(19) United States
(12) Patent Application Publication
(10) Pub. No.: US 2008/0139101 A1
(43) Pub. Date: Jun. 12, 2008

(54) Venting arrangement

(75) Inventors: Randy Allen Bickel, Edwardsburg, MI (US); Leo Monte Holmes, Goshen, IN (US); Matthew James Copeland, Middlebury, IN (US)

Correspondence Address: CALFEE HALTER & GRISWOLD, LLP, 800 SUPERIOR AVENUE, SUITE 1400, CLEVELAND, OH, 44114, US

(73) Assignee: PHILIPS PRODUCTS, INC., Elkhart, IN (US)

(21) Appl. No.: 11/999,213

(22) Filed: Dec. 4, 2007

Related U.S. Application Data
(60) Provisional application No. 60/872,964, filed on Dec. 4, 2006.

(51) Int. Cl. B60H 1/26; F24F 7/02; F24F 13/20; E05F 11/12

(52) U.S. Cl. 454/136; 454/275; 49/342

(57) ABSTRACT

A venting arrangement that includes a lid pivotally attached to a frame. An operating mechanism moves the lid between an open and closed position and attaches to a guide associated with the lid. The lid may be formed as a single, integral piece, including a portion for attaching the lid to the frame and the guide. The operating mechanism may include a engagement portion that attaches to the guide that is designed with geometry that creates a surface area contact between the mechanism and guide. The engagement portion may include a surface that engages one or more surfaces on the guide, which extend substantially parallel to the engagement portion surface. The arrangement may also include a feature that resists movement of the lid from a set position or that limits the travel of the mechanism at specific points along the mechanism's operational range.

### RELATED APPLICATIONS

This application claims priority to, and any benefit of, U.S. Provisional Patent Application Ser. No. 60/872,964, filed on Dec. 4, 2006, entitled VENTING ARRANGEMENT, the entire disclosure of which is fully incorporated herein by reference.

### BACKGROUND

Structures, especially enclosed structures in which people reside, often need to vent the interior of the structure to recirculate air, provide cooling, etc. These structures may include stationary structures, such as buildings, or non-stationary structures, such as vehicles and trailers. Vents and/or other venting arrangements are conventionally provided in such structures to provide the desired venting. These venting structures often have a lid or cover that can be moved to open and close the vent opening.

### SUMMARY

The present application discloses a venting arrangement. In particular the application discloses a venting arrangement that includes a lid pivotally attached to a frame. The lid may be moved between an open and closed position by a mechanism associated with the frame and attached to a guide associated with the lid.

In accordance with one exemplary embodiment, the lid may be formed as a single piece that may include a portion for attaching the lid to the frame and a guide for attaching to the mechanism. In accordance with another exemplary embodiment, the mechanism may include an engagement portion that attaches to the guide. The mechanism and guide may be designed with geometry that creates a surface area contact between the mechanism and guide. The engagement portion may include a surface that engages one or more surfaces on the guide, which extend substantially parallel to the engagement portion surface.

In accordance with yet another exemplary embodiment, the arrangement may include a feature that resists movement of the lid from a set position or that limits the travel of the mechanism at specific points along the mechanism's operational range. In one exemplary embodiment, the feature may include a protuberance on the guide that snaps into a depression or groove in the engagement portion of the mechanism. In another exemplary embodiment, the feature may be build into the operating mechanism or an actuating device, such as a handle or knob, of the arrangement.

Further aspects and concepts will become apparent to those skilled in the art after considering the following description and appended claims in conjunction with the accompanying drawings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of the invention:

FIG. 1 is perspective view of an exemplary embodiment of a roof vent;

FIG. 2A-2B are perspective views of a bottom of a lid and guide for the exemplary roof vent of FIG. 1;

FIG. 3 is a cross sectional view taken along section line A-A in FIG. 4 of an exemplary connection between a lid and an operator mechanism for the exemplary roof vent of FIG. 1;

FIG. 4 is a partial perspective view of a portion of the lid for the exemplary roof vent of FIG. 1, which resists movement of the lid when closed;

FIG. 5 is side view of another embodiment of an exemplary connection between a lid and an operator mechanism for an exemplary roof vent;

FIG. 6A-6B are cross-sectional views taken along section line B-B in FIG. 5 of two exemplary connections between a lid and an operator mechanism for an exemplary roof vent;

FIG. 7A-7E are cross-sectional views of additional embodiments of exemplary connections between a lid and an operator mechanism for an exemplary roof vent;

FIG. 8A-8B are side views of exemplary embodiments of features of the exemplary roof vent that resist movement of the lid from a set position;

FIG. 9 is a partially exploded view of an exemplary embodiment of a mechanism for moving a lid of an exemplary roof vent;

FIG. 10 is a partially sectioned view of the mechanism of FIG. 10 in a first position, the section taken adjacent to and parallel with the surface of arm 118 as illustrated; and

FIG. 11 is a partially sectioned view of the mechanism of FIG. 10 in a second position, the section taken adjacent to and parallel with the surface of arm 118 as illustrated; and

FIG. 12 is a partially sectioned view of another exemplary embodiment of a mechanism for moving a lid of an exemplary roof vent.

### DETAILED DESCRIPTION

The present application discloses a venting arrangement. While the exemplary embodiments illustrated and described herein are presented in the context of a rectangular roof vent for use with recreational vehicles, those skilled in the art will readily appreciate that the present invention may be used and configured in other ways. For example, the arrangement may be used with a variety of structures or devices, both stationary and non-stationary. The arrangement may also be used in a building such as an enclosed shed, a vehicle such as a recreational vehicle or enclosed trailer, or any other structure in which ventilation is desired. In addition, the arrangement may be used in a roof of a structure, but may also be installed on other surfaces, such as a sidewall, for example. Furthermore, the shape of the arrangement may be any geometric configuration, such as rectangular, circular or any other shape.

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

The exemplary embodiments of a venting arrangement disclosed in the present application include a lid pivotally attached to a frame and an operating mechanism configured to move the lid between an open and closed position. The operating mechanism attaches to a guide associated with the lid. The lid may be formed as a single, integral piece, including a portion for attaching the lid to the operating mechanism and a portion for attaching the lid to the frame. The operating mechanism may include an engagement portion that attaches to the guide. The engagement portion may be designed with geometry that creates a surface area contact between the mechanism and guide. The engagement portion may include a surface that engages one or more surfaces on the guide, which extend substantially parallel to the engagement portion surface. The venting arrangement may also include a feature that resists movement of the lid from a set position or that limits the travel of the mechanism at specific points along the mechanism's operational range.

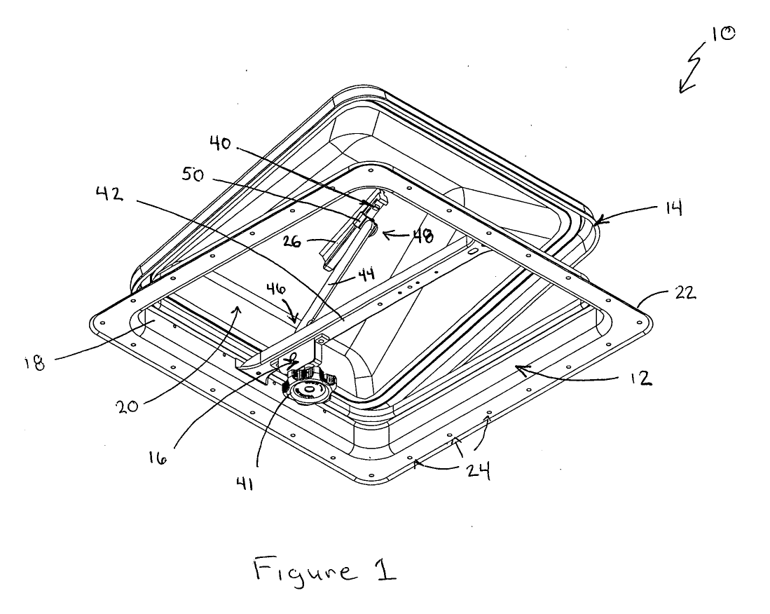

Referring now to the Figures, FIG. 1 illustrates an exemplary venting arrangement 10. The arrangement 10 may include a frame 12, a lid 14, and an operating mechanism 16. The frame 12 may include a periphery 18 that defines an opening 20 radially inward from the periphery. The periphery 18 may include a radially extending flange 22 for mounting the frame 12 to a structure (not shown). The frame may mount to any suitable structure, such as for example, a recreational vehicle, an enclosed shed, an enclosed trailer, or any structure in which ventilation is desired.

The structure (not shown) may include a wall, roof or other portion having an opening, which may be about the same size as the opening 20 and to which the shape of the frame 12 may generally match. The radially extending flange 22 may include a plurality of fastener openings 24 for receiving fasteners that attach the frame 12 to the structure. The frame 12, however, may attach to the structure in any suitable manner.

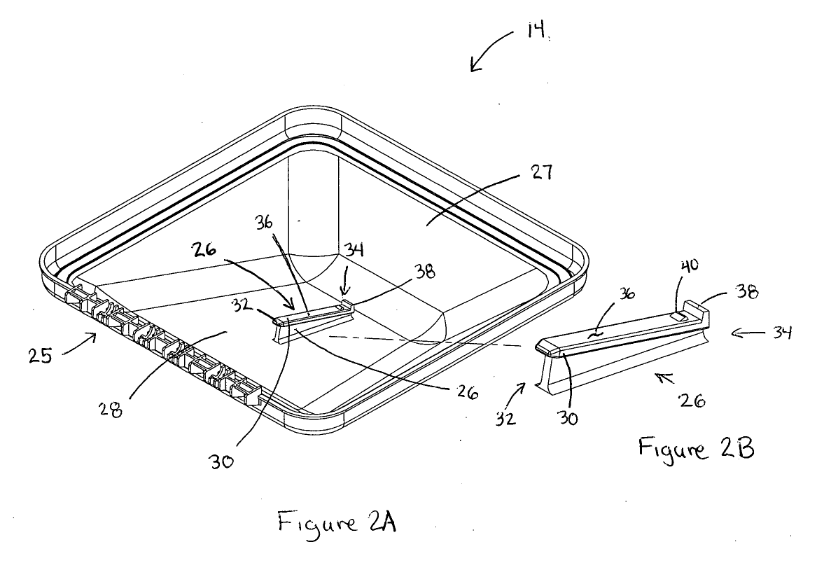

The lid 14 may be configured to attach to the frame 12 for moving between a first position in which the lid generally covers the opening 20 and a second position in which the lid is generally pivoted away from or uncovers the opening 20. The lid 14 (see FIG. 2A) may have a flat, concave, or convex body portion 27 and may include a portion 25 for attaching to the frame 12 that may be, but not necessarily be, integral with the lid 14. In the depicted exemplary embodiment, the portion 25 is realized as a hinge section for pivotally attaching to a corresponding hinge portion of the frame 12.

The lid 14 may also include a guide 26. The guide 26 may be integrally formed with the lid 14 and extend from a surface 28 of the lid 14. In the depicted exemplary embodiment, the guide 26 includes a generally T-shaped extension 30 (a proximal narrower portion 60 and a distal wider portion 62 as shown in FIG. 3) having a first end 32 and a second end 34. The guide 26 may include a generally planar surface 36 that is sloped relative to the lid surface 28. The guide 26 may also include a positive stop 38 at an end and a portion 40 that causes an increased closure force of the lid 14 or resists movement of the lid from its closed position (discussed in detail below).

The lid 14 may be formed from a variety of materials. In one embodiment, the lid 14 is formed from a moldable plastic, such as for example molded from polyethylene, polypropylene, or polycarbonate. The lid 14 or a portion of the lid may be generally transparent or translucent. The lid 14 may be, but not necessarily be, formed as a single piece, including the guide 26 and the hinge portion 25. Thus, the guide 26 and hinge portion 25 may be constructed from the same material as the lid 14 and no additional parts, joints, or fasteners may be required.

The operator mechanism 16 may be used to move the lid 14 between the first position and the second position. The operator mechanism 16 may be associated with the frame 12, but that is not required. The operator mechanism 16 is operated by an actuating device 41. The actuating device may be manual, such as a knob or handle, for example, or powered by a power source, such as an electric motor, for example, as is known in the art.

In the depicted embodiment in FIG. 1, the frame 12 includes a cross member 42 that spans the opening 20. The cross member 42 may support the operator mechanism 16. The operator mechanism 16 may include an arm 44 having a first end 46 that is pivotally mounted and a second end 48 that is slideably attached to the guide 26 by an engagement portion 50. The attachment between the second end 48 of the arm and the guide 26 may be configured in a variety of ways to allow sliding movement. The engagement portion 50 and guide 26 may be configured to create surface area contact between the operator mechanism 16 and the guide 26. Surface area contact, as compared to point contact or line contact, may provide superior stress distribution and may provide smoother movement of the lid that substantially reduces or eliminates binding or chatter.

As shown in FIGS. 3-4, in the depicted embodiment, the engagement portion 50 may be realized as a clip that is configured to have an inner surface 52 that substantially conforms to the shape or contour of the T-shaped extension 30. The inner surface 52 defines an opening in which the T-shaped extension 30 is received. The T-shaped extension 30 may include one or more surfaces, e.g., the surface 36, that engage and extend substantially parallel to the inner surface 52 of the engagement portion. In the depicted embodiment, the inner surface 52 contacts the T-shaped extension 30 on at least three surfaces (five such contact surfaces are shown) for increased area of the surface contact.

Additional embodiments of the attachment between the operator mechanism 16 and the lid 14 are possible. For example, in the exemplary embodiment depicted in FIG. 5, a lid 70 (which may be the same as lid 14, except as described below) includes a guide 72 having a slot 74. An arm 76 of an operator mechanism (not shown, which may be the same as any of the various operator mechanisms shown and/or described herein) may be slideably attached to the slot 74 via a pin 78 such that movement of the arm moves the lid 70. The pin 78 may include flats 80 for engaging the slot 74 such that there is surface area contact between the pin 78 and the guide 72.

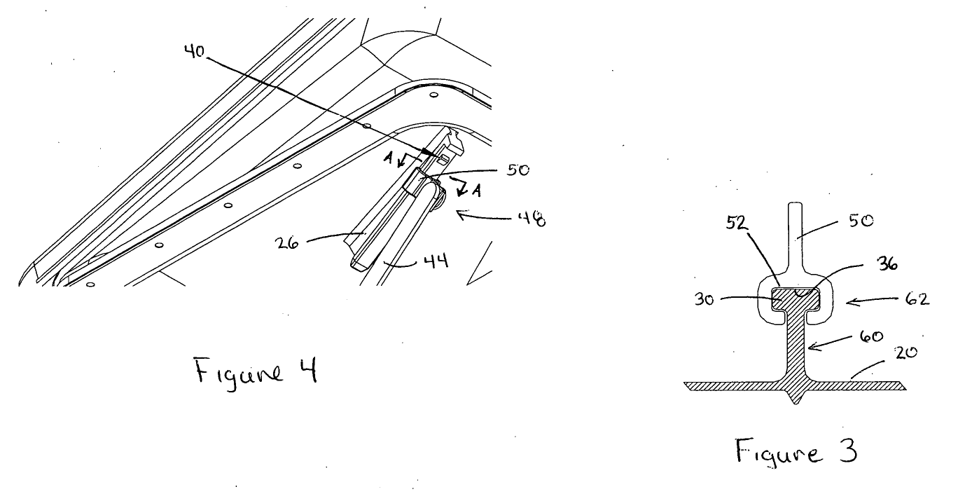

FIGS. 6A and 6B illustrate two exemplary embodiments of the attachment between the lid 70 and the guide 72 of FIG. 5. In FIG. 6A, two substantially parallel guides 72′, 72″ are provided, each including a slot 74′, 74″. The arm 76 may extend between the two guides 72′, 72″ such that the pin 78 may engage both slots 74′, 74″ and the arm 76.

In FIG. 6B, a single guide 72 and slot 74 are provided and the arm 76 is positioned adjacent the guide 72 such that the pin 78 may engage both the slot 74 and the arm 76. The pin may be retained in the slot 74 by a variety of suitable methods, such as for example a threaded fastener, a cotter pin, rivet with a standoff, or other suitable retaining means. In FIG. 6B, for example, the pin 78 may include a head portion 82 that is larger than the slot 74 to prevent the arm 76 from disengaging with the guide 72 during operation. The slot 74 may include an enlarged opening 84 (FIG. 5) to facilitate assembly of the arm 76 to the guide 72 and allow disassembly of the arm 76 from the guide 72 when desired.

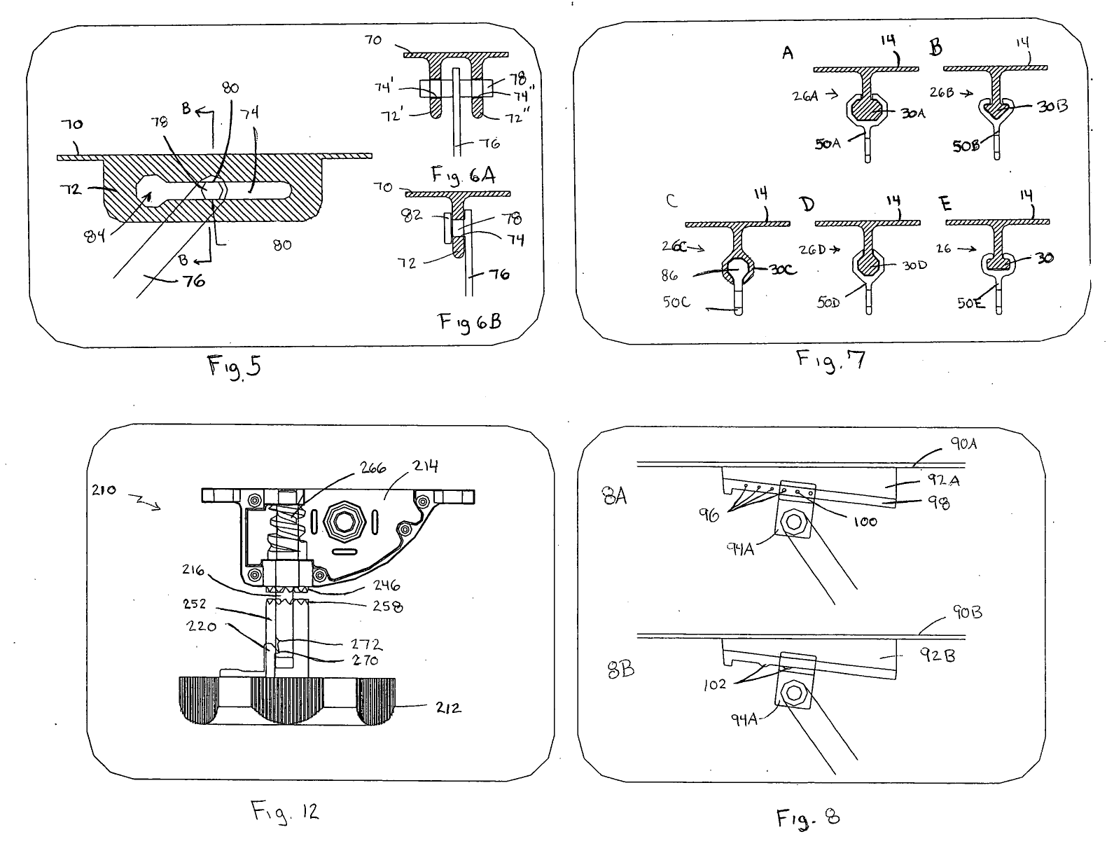

FIGS. 7A-7D illustrate additional exemplary embodiments of the attachment between the lid 14 and the guide 26 of the arrangement of FIG. 1. FIG. 7E illustrates the embodiment of the attachment described in FIG. 3. FIGS. 7A-7D illustrate that a variety of suitable geometries may serve as means for creating surface area contact between the guide 26 and the operator mechanism 16 (not shown). For example, in FIG. 7E, the T-shaped extension 30 may be described as including five contact surfaces to which the engagement portion 50 may contact. The geometries of guide extensions 30A, 30B, and 30D may be described as providing nine, four, and seven contact surfaces, respectively.

The exemplary embodiment in FIG. 7C illustrates that guide and engagement mechanism geometries may be reversed. For example, the guide 26C may include a clip-like extension 30C that forms a channel and the engagement mechanism 50C may include an extension 86 that conforms to the shape of the channel, thus providing surface area contact between the guide 26C and the engagement mechanism 50C. Virtually any of the various guides and engagement mechanism geometries may be reversed in a manner exemplified by the reversed structures of FIG. 7C and FIG. 7D.

Referring to FIG. 4, the portion 40 that resists movement of the lid 14 from a set position may be a detent or other feature/mechanism that temporarily keeps the lid 14 closed relative to the opening 20 and can be released by applying force to the lid. The detent may be a spring-loaded piece or may rely on the elasticity of the cooperating parts. In the depicted embodiment in FIG. 4, the portion 40 is realized as a protuberance or button positioned proximate the second end 34 of the guide 26. The protuberance 40 is designed to engage the clip 50 as it slides along the guide 26. The protuberance 40 may engage the clip 50 in an interference fit when the lid 14 reaches the closed position; thus holding the lid 14 in the closed position and resisting inadvertent opening of the lid. In one embodiment, the clip 50 may also include a depression, hole, or groove (not shown) along the inner surface 52 for receiving the protuberance 40. In this manner, the protuberance 40 snaps into the depression when the lid 14 reaches the closed position.

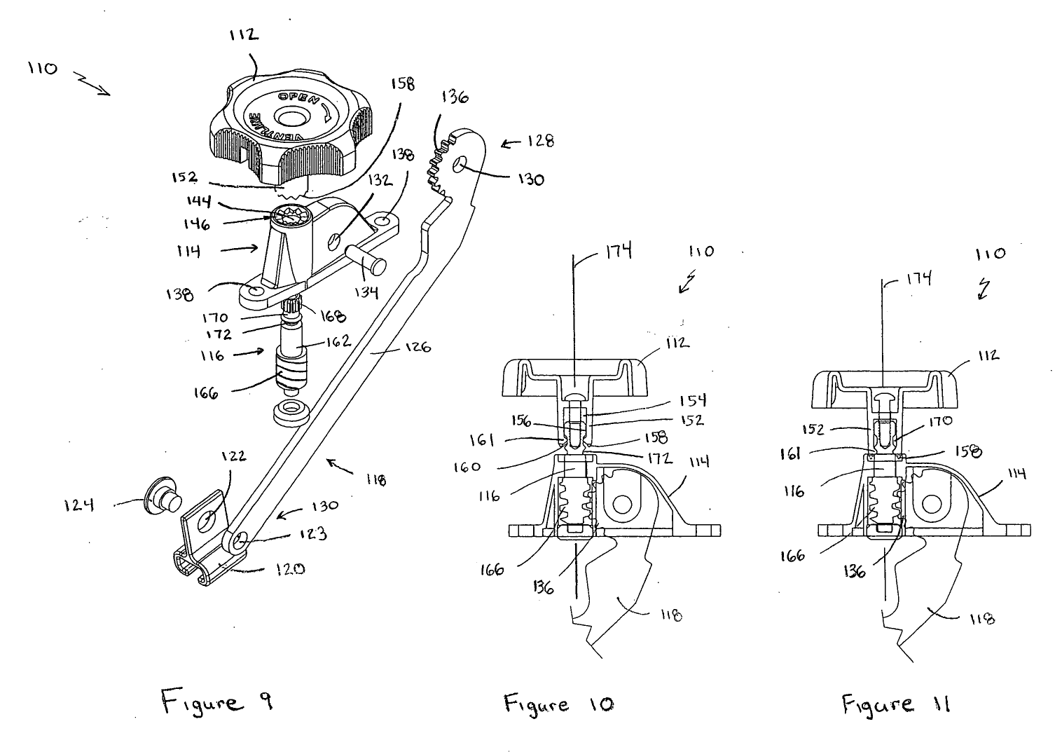

The means for resisting movement of the lid 14 from a set position, however, may be configured in a variety of ways other than the depicted protuberance 40. For example, a protuberance realized as a rib, a button or any other suitable structure may cooperate with a corresponding depression realized as a groove, notch, hole or any other suitable structure. The protuberance may be on the guide or on the attachment portion of the operator mechanism with the depression on the other corresponding structure. The portion may include an interference fit, line-to-line fit or other suitable method for resisting opening of the lid. Furthermore, at the end of travel of the attachment device, a rough surface, ribbed area, or other suitable feature may be provided that creates friction between the guide and attachment device. The friction may act to resist movement of the lid from the closed position. Still further, a means for resisting movement of the lid from a set position may be included with the operating mechanism and actuating device (as discussed in relation to FIGS. 9-12 below).

FIGS. 8A and 8B illustrate two exemplary embodiments of the portion for resisting movement of a lid 90 from a set position. In FIG. 8A, a T-shaped guide 92A and an engagement mechanism 94 A are illustrated, which may be the same as the guide 26 and engagement mechanism 50 of FIG. 4, except the portion for resisting movement may be realized as a series of protrusions 96 located on a side surface 98 of the T-shaped guide. The engagement mechanism 94A may include one or more holes or grooves 100 for receiving one of the series of protrusions 96. Once received, the engagement of a protrusion 96 and a hole 100 may resist further movement of the mechanism 94A along the guide 92A.

In FIG. 8B, a guide 92B may include plurality of protuberances 102 similar to the protuberance 40 of FIG. 4. Multiple protuberances 102 may allow the lid 90B to be secured or locked fully open, fully closed and/or in various positions in between.

FIGS. 9-11 illustrate another exemplary embodiment of a feature for resisting movement of a lid (not shown) from a set position. In the depicted embodiment, the feature for resisting movement of a lid (not shown) is built into the operating mechanism 110 or an operator handle or knob 112 of the arrangement. The feature, when used, may prevent further rotation of the knob 112.

Referring to FIG. 9, the operator mechanism 110 includes the knob 112, a housing portion 114, a shaft 116, an arm 118, and an engagement mechanism 120 for connecting the arm to a lid (not shown). The engagement mechanism 120 can be any suitable mechanism for attaching the arm 118 to the lid. In the depicted embodiment, the engagement mechanism 120 is the same as the engagement mechanism 50E, illustrated in FIG. 7E. The engagement mechanism 120 may attach to the arm 118 in any suitable manner. In the depicted embodiment, the engagement mechanism 120 includes an aperture 122 that corresponds to an aperture 123 in the arm 118. A fastener 124, such as a pin, is received by both the aperture 122 in the engagement mechanism 120 and the aperture 123 in the arm to pivotally attach the arm to the engagement mechanism 120.

The arm 118 has a generally elongated body 126 having a first end 128 and a second end 130. The first end 128 is adapted to be pivotally attached to the housing portion 114 by any suitable means. In the depicted embodiment, the first end 128 includes a fastener opening 130 corresponding to a fastener opening 132 in the housing portion 114. A fastener 134, such as a pin, is received by both the fastener opening 130 in the arm 118 and the fastener opening 132 in the housing portion 114 to pivotally mount the arm 118 to the housing portion.

The first end 128 of the arm 118 also includes gear teeth 136 adapted to mate with corresponding gear teeth 166 on the shaft 116, as will be described in more detail below.

The housing portion 114 is adapted to mount onto a frame (not shown in FIGS. 9-11), which may be similar to the frame 12 of FIG. 1, by any suitable means. In the illustrated embodiment, the housing portion 114 includes a plurality of openings 138 configured to receive fasteners for mounting the housing portion 114 to a frame. The housing portion 114 is configured to house and pivotally mount the first end 128 of the arm 118 and gear teeth 166. In addition, the housing portion 114 includes an opening 144 for receiving the shaft 116. The housing portion 114 also includes a set of circumferentially extending teeth 146 circumscribing the opening 144 for mating with a corresponding set of teeth on the knob 112 to prevent rotation of the knob.

The knob 112 includes a hollow stem 152 adapted to receive the shaft 116 within a chamber 154 defined by an inner surface 156 (see FIG. 10). The stem 116 has a set of circumferentially extending teeth 158 adapted to mate with the circumferentially extending teeth 146 on the housing portion 114 and an opening 160 (FIG. 10) for receiving the shaft 116. The teeth 158 face away from the knob 112 and circumscribe the opening 160. A portion of the inner surface 156 is splined and adapted to form a splined connection with the shaft 116. The hollow stem 152 also includes an radially inward facing projection 161. The projection 161 may be formed as a single annular projection or one or more projections arranged around the inner surface 156 of the shaft 116.

The shaft 116 has a generally elongated body 162 that includes a gear 166 that is configured to mate with the gear teeth 136 on the first end 128 of the arm 118. In the depicted embodiment, the gear teeth 136 and the gear 166 are generally configured as a worm (gear 166) and worm gear (gear teeth 136) arrangement, though other configurations are possible. Any arrangement that converts rotational movement of the knob to pivotal movement of the arm 118 may be used.

The shaft 116 also includes a splined portion 168 for mating with the splined inner surface 156 of the stem 152. The shaft 116 also includes a first circumferential groove 170 and a second circumferential groove 172 positioned between the splined portion 168 and the gear 166.

When assembled, the shaft 116 is mounted within the housing 114 and rotatable about a longitudinal axis 174. The first end 128 of the arm 118 is pivotally mounted within the housing 114 such that the gear teeth 136 mate with the gear 166 on the shaft 116. The knob 112 is attached to the shaft 116 and, due the splined connection, rotates the shaft when the knob is rotated. In addition, the knob 112 may move axially between a first position and a second position relative to the housing 114.

FIG. 10 illustrates the operating mechanism 110 when the knob 112 is in the first position. In the first position, the projection 161 is positioned within the first circumferential groove 170. The projection 161 and the first circumferential groove 170 act as a detent that temporarily keeps that knob 112 in the first position relative to the housing 114. In the first position, the teeth 158 on the stem 152 are spaced apart from the teeth 146 on the housing portion 114. Thus, the knob 112 can be rotated about the axis 174. Rotation of the knob 112, rotates the shaft 116. Due to the engagement between the gear 166 on the shaft 116 and the gear teeth 136 on the arm, rotation of the shaft pivots the arm, thus opening and closing the lid (not shown in FIGS. 9-11).

FIG. 11 illustrates the operating mechanism 110 when the knob 112 is in the second position. In the second position, the projection 161 is positioned within the second circumferential groove 172. The projection 161 and the second circumferential groove 172 act as a detent that temporarily keeps that knob 112 in the second position relative to the housing 114. The stem 152 is formed, at least in part, by a resilient material, such as plastic. When sufficient axial force is applied to the knob 112, the projection 161 and/or stem 152 may flex out of the groove to allow the knob 112 to move between the first and second positions. When the projection 161 is positioned at the first or second circumferential groove 170, 172, the projection returns to a position in which it extends into the groove.

In the second position, the teeth 158 on the stem 152 mate with the teeth 146 on the housing portion 114 to prevent or resist rotation of the knob 112 about the axis 174. Thus, due to the operational connection between the knob 112 and the lid (not shown), when the knob is in the second position, the mechanism 110 resists movement of the lid. Accordingly, the second position may be considered to be a locked position and the first position may be considered to be an unlocked position. The means for preventing or resist rotation of the knob (and resists movement of the lid) may be configured other than mating pairs of circumferentially extending teeth. Any structure that engages the knob or stem in a manner that prevents or resists rotation of the knob when the knob is in the second position may be used.

FIG. 12 illustrates another exemplary embodiment of a feature for resisting movement of a lid (not shown in FIG. 12) from a set position. The operating mechanism 210 may be the same as or similar to the mechanism illustrated in FIGS. 9-11, except that the feature for resisting movement of a lid is modified.

As with the embodiment of FIGS. 9-11, in the depicted embodiment, the operator mechanism 210 includes the knob 212, a housing portion 214, a shaft 216, and an arm (not shown). The knob 212 includes a hollow stem 252 having a set of teeth 258 at an end opposite the knob 212. A mating set of teeth 246 are disposed on the housing portion 214. The knob 212 and stem 252 are axially movable relative to the housing portion 214 between a first position where the sets of teeth 258, 246 are not engaged and a second position where the set of teeth are engaged.

The hollow stem 252 is adapted to receive the shaft 216 such that rotation of the knob 212 rotates the shaft 216. The shaft 216 includes a gear 266 adapted to mate with a gear (not shown) on the arm (not shown). The shaft 216 also includes first notch 270 and a second notch 272 and the knob 212 includes a stop catch 220. In the first position, the stop catch 220 engages the first notch 270 such that rotational movement of the knob 212 is transmitted to the shaft 218 and the knob 212 is held in the first position. Thus, the engagement between the stop catch 220 and the first notch 270 serves both to fix the knob 212 to the shaft 216 for rotation therewith and to retain the knob in the first position. In the second position, the stop catch 220 engages the second notch 272 to retain the knob 212 in the second position. In addition, the engagement of the sets of teeth 258, 246 prevents rotation of the knob 212; thus, the operator mechanism and the lid are effectively locked or secured in a set position. Accordingly, the second position may be considered to be a locked position and the first position may be considered to be an unlocked position.

The invention has been described with reference to the preferred exemplary embodiments. Modification and alterations will occur to others upon a reading and understanding of this specification. It is intended to include all such modifications and alterations insofar as they come within the scope of the appended claims or the equivalents thereof.

1. A venting arrangement, comprising:
a frame;
a lid pivotally attached to the frame for movement between a first position and a second position, the lid including an integrally formed guide; and
a mechanism associated with the frame for pivoting the lid between the first position and the second position, the mechanism including a housing attached to the frame and an arm having a first end slidably attached to the guide by an engagement portion and a second end pivotally attached to the housing, the engagement portion having a surface that engages a surface on the guide, wherein the surface of the engagement portion and the surface of the guide extend substantially parallel to each other.

2. The arrangement of claim 1 wherein the lid and the guide are formed as a single piece of moldable plastic.

3. The arrangement of claim 2 wherein the moldable plastic is transparent or translucent.

4. The arrangement of claim 1 wherein the guide extends from a lid surface, and wherein the surface of the guide that engages the surface of the engagement portion is sloped relative to the lid surface.

5. The arrangement of claim 1 wherein the guide includes a plurality of surfaces that engage a plurality of corresponding surfaces on the engagement portion.

6. The arrangement of claim 5 wherein at least one of the plurality of surfaces on the guide engaging the engagement portion is nonparallel with at least one other of the plurality of surfaces on the guide engaging the engagement portion.

7. The arrangement of claim 5 wherein the guide has a generally T-shaped cross-section.

8. The arrangement of claim 1 further comprising a portion that resists movement of the lid from a set position.

9. The arrangement of claim 8 wherein the portion that resists movement of the lid from a set position is located on the integrally formed guide.

10. The arrangement of claim 9 wherein the portion for resisting movement of the lid from a set position is a detent.

11. The arrangement of claim 8 wherein the portion that resists movement of the lid from a set position holds the lid in a closed position.

12. The arrangement of claim 8 wherein the portion that resists movement of the lid from a set position is included in the mechanism for pivoting the lid.

13. The arrangement of claim 12 further comprising an actuating device, wherein the portion that resists movement of the lid comprises a set of teeth on the housing that engage a set of teeth on the actuating device.

14. A lid for a roof vent having a frame for mounting to a structure, comprising:
a body portion;
a hinge portion for pivotally attaching to the frame; and
a guide extending outward from a surface on the body portion for attaching to an operating mechanism that opens and closes the lid; the guide including a portion for resisting movement of the lid from a set position and a generally elongated surface adapted to slidably engage a generally parallel surface on the operating mechanism.
wherein the body portion, the hinge portion, and the guide are formed as a single, integral piece.

15. The lid of claim 14 wherein the generally elongated surface on the guide is sloped relative to the surface on the body portion to which the guide extends from.

16. The arrangement of claim 14 wherein the guide includes a plurality of generally elongated surfaces adapted to engage a plurality of corresponding surfaces on the engagement portion.

17. The arrangement of claim 15 wherein at least one of the plurality of surfaces on the guide is nonparallel with at least one other of the plurality of surfaces on the guide.

18. The lid of claim 17 wherein the guide has a generally T-shaped cross-section.

19. A venting arrangement, comprising:
a frame;
a lid pivotally movable relative to the frame, the lid having an integral guide;
a mechanism associated with the frame for opening and closing the lid, the mechanism attached to the lid by a means for creating surface area contact between the guide and the mechanism.

20. The venting arrangement of claim 15 wherein the mechanism includes an engagement portion having a surface configured to conform to the contour of the guide.

21. The venting arrangement of claim 15 wherein the means for creating surface area contact between the guide and the mechanism comprises engaging a plurality of surfaces on the guide.

22. The arrangement of claim 21 wherein at least one of the plurality of surfaces on the guide is nonparallel with at least one other of the plurality of surfaces on the guide;

23. The venting arrangement of claim 15 further comprising a means for retaining the lid in a set position.

24. The venting arrangement of claim 23 wherein a portion of the means for retaining the lid in a set position is located on the integral guide.

25. A venting arrangement for a structure, comprising:
a frame attachable to the structure, the frame having a periphery and an opening radially inward of the periphery;
a lid hingedly attached to the frame, the lid moveable between a first position in which the lid generally covers the opening and a second position in which the lid is generally pivoted away from the opening; the lid having an integral, generally T-shaped extension, the extension including a detent that resists movement of the lid from the first position; and
a mechanism associated with the frame for moving the lid, the mechanism including a housing attached to the frame and an arm having a first end slideably attached to the guide by a clip and a second end pivotally attached to the housing; the clip adapted to conform to the shape of the generally T-shaped extension and slide along the extension as the lid opens and closes.

26. The venting arrangement of claim 25 wherein the clip further comprises an inner surface defining an opening; the inner surface contacting the T-shaped extension on at least three surfaces of the extension.

27. The venting arrangement of claim 25 wherein the clip further comprises a generally T-shaped opening that accepts the T-shaped extension.

28. An operating mechanism for opening and closing a roof vent lid, comprising:
a housing;
an arm pivotally mounted to the housing;
a shaft rotatably mounted within the housing; the shaft having a first end that extends out of the housing along an axis and a second end adapted to engage with the arm;
a rotatable actuating device having a hollow stem that receives the first end of the shaft; the actuating device connected to and rotatable with the shaft, the actuating device movable between a first axial position and a second axial position relative to the shaft,
wherein in the first axial position the stem and the housing are spaced apart and in the second axial position the stem engages the housing to prevent rotation of the actuating device.

29. The operating mechanism of claim 28 wherein the housing comprises a first set of teeth and the stem comprises a second set of teeth that mate with the first set of teeth when the actuating device is in the second position.

30. The operating mechanism of claim 28 wherein the actuating device comprises a knob.

31. The operating mechanism of claim 28 wherein the shaft further comprises a circumferential groove and the stem further comprises a radially inwardly extending projection engageable with the circumferential groove to resist movement of the actuating device from a set position.

32. The operating mechanism of claim 28 wherein the actuating device and the shaft form a splined connection.

33. The operating mechanism of claim 28 wherein the shaft includes gear teeth that mate with gear teeth on the arm such that rotation of the shaft pivots the arm.

34. An operating mechanism for opening and closing a roof vent lid, comprising:
a housing having a first set of circumferentially extending teeth;
an arm pivotally mounted to the housing, the arm including a first set of gear teeth;
a shaft rotatably mounted within the housing; the shaft having a first end that extends out of the housing along an axis, a second end having a second set of gear teeth that mate with the first set gear teeth on the arm such that rotation of the shaft pivots the arm, and a circumferential groove disposed between the first end and the second end,
a rotatable actuating device having a hollow stem that receives the first end of the shaft to form a splined connection between the actuating device and the shaft; the stem having a second set of circumferentially extending teeth and a radially inwardly extending projection engageable with the circumferential groove to resist movement of the actuating device from a set axial position, the actuating device connected to and rotatable with the shaft, the actuating device movable between a first axial position and a second axial position relative to the shaft,
wherein in the first axial position the stem and the housing are spaced apart and in the second axial position the stem engage the housing such that the second set of circumferentially extending teeth mate with the first set of circumferentially extending teeth to prevent rotation of the actuating device.
